(19) United States
(12) Patent Application Publication
(10) Pub. No.: US 2023/0283963 A1
(43) Pub. Date: Sep. 7, 2023

(54) MICROPHONE ASSEMBLY AND PACKAGING METHODS FOR SIZE REDUCTION AND BACK VOLUME INCREASE

(71) Applicant: Skyworks Solutions, Inc., Irvine, CA (US)

(72) Inventors: Guofeng Chen, Fremont, CA (US); Rakesh Kumar, Singapore (SG); You Qian, Singapore (SG); Michael Jon Wurtz, Lake Oswego, OR (US); Humberto Campanella-Pineda, Singapore (SG)

(21) Appl. No.: 18/176,598

(22) Filed: Mar. 1, 2023

Related U.S. Application Data
(60) Provisional application No. 63/316,655, filed on Mar. 4, 2022.

(51) Int. Cl. H04R 17/02; H04R 1/04; H04R 1/08; H04R 3/00

(52) U.S. Cl. CPC H04R 17/02; H04R 1/04; H04R 1/086; H04R 3/00; H04R 2201/003

(57) ABSTRACT

A piezoelectric microelectromechanical system microphone assembly comprises a carrier substrate including one of a through-hole or a recess, and a package including a microelectromechanical system die having a piezoelectric microelectromechanical system microphone mounted on a microphone substrate and a lid, at least a portion of the package disposed within the one of the through-hole or recess.

### CROSS-REFERENCE TO RELATED APPLICATIONS

This application claims priority under 35 U.S.C. § 119(e) to U.S. Provisional Patent Application Serial No. 63/316,655, titled “MICROPHONE ASSEMBLY AND PACKAGING METHODS FOR SIZE REDUCTION AND BACK VOLUME INCREASE,” filed Mar. 4, 2022, the entire content of which is incorporated herein by reference for all purposes.

### BACKGROUND

### Technical Field

Embodiments disclosed herein relate to piezoelectric microelectromechanical system microphone packages and to devices including same.

### Description of Related Technology

A microelectromechanical system (MEMS) microphone is a micro-machined electromechanical device to convert sound pressure (e.g., voice) into an electrical signal (e.g., voltage). MEMS microphones are widely used in mobile devices such as cellular telephones, headsets, smart speakers, and other voice-interface devices/systems. Capacitive MEMS microphones and piezoelectric MEMS microphones (PMMs) are both available in the market. PMMs requires no bias voltage for operation, therefore, they provide lower power consumption than capacitive MEMS microphones. The single membrane structure of PMMs enable them to generally provide more reliable performance than capacitive MEMS microphones in harsh environments. Existing PMMs are typically based on either cantilever MEMS structures or diaphragm MEMS structures.

Some of the important parameters to consider in the design of a PMM include performance parameters such as SNR (signal to noise ratio), bandwidth (related to frequency response flatness), size, and cost.

The performance of a PMM is largely affected by the size of the PMM, as a larger size may provide for a larger back volume to increase the SNR of the microphone. However, microphone size is becoming a more important design consideration as mobile devices or headsets in which such PMMs are utilized are shrinking and/or including additional functionality and related circuitry and less area is becoming available within the devices for PMMs. Performance of existing PMM designs is typically degraded as designers attempt to reduce the size of the PMMs to meet customer requirements.

### SUMMARY

In accordance with one aspect, there is provided a piezoelectric microelectromechanical system microphone assembly. The piezoelectric microelectromechanical system microphone assembly comprises a carrier substrate including one of a through-hole or a recess, and a package including a microelectromechanical system die having a piezoelectric microelectromechanical system microphone mounted on a microphone substrate and a lid, at least a portion of the package disposed within the one of the through-hole or recess.

In some embodiments, the lid is a metal lid.

In some embodiments, the lid is at least partially disposed within the one of the through-hole or recess.

In some embodiments, the lid is fully disposed within the one of the through-hole or recess.

In some embodiments, an upper surface of the lid is substantially co-planar with a lower surface of the carrier substrate.

In some embodiments, the lid is formed over the microelectromechanical system die and, together with the microphone substrate, defines a back volume around the piezoelectric microelectromechanical system microphone.

In some embodiments, the package is a bottom-port package.

In some embodiments, a piezoelectric membrane of the piezoelectric microelectromechanical system microphone is disposed proximate the bottom port and between the bottom port and a support substrate for the piezoelectric membrane.

In some embodiments, the lid and microelectromechanical system die are disposed on opposite sides of the microphone substrate.

In some embodiments, the microelectromechanical system die is at least partially disposed within the one of the through-hole or the recess.

In some embodiments, the one of the through-hole or the recess is the recess, and the carrier substrate further includes an opening providing acoustic communication between the microelectromechanical system microphone and an environment outside of the package.

In some embodiments, the lid is at least partially disposed within the one of the through-hole or the recess.

In some embodiments, the one of the through-hole or the recess is the through-hole.

In some embodiments, the package is encapsulated by a conductive material.

In some embodiments, the assembly further comprises a mesh disposed over a piezoelectric membrane of the microelectromechanical system microphone.

In some embodiments, the mesh is conductive.

In some embodiments, the mesh is grounded.

In some embodiments, the assembly further comprises an application specific integrated circuit disposed within the package.

In some embodiments, the assembly is included in an electronics device module.

In some embodiments, the electronics device module is included in an electronic device.

### BRIEF DESCRIPTION OF THE DRAWINGS

Embodiments of this disclosure will now be described, by way of non-limiting example, with reference to the accompanying drawings.

FIG. 1A is a plan view of an example of a cantilever piezoelectric microelectromechanical system microphone (PMM);

FIG. 1B is a cross-sectional view of the cantilever PMM of FIG. 1A;

FIG. 2A is a plan view of an example of a diaphragm PMM;

FIG. 2B is a cross-sectional view of the diaphragm PMM of FIG. 2A;

FIG. 3 illustrates an example of a bottom-port packaging structure for a PMM;

FIG. 4A illustrates an example of a top-port packaging structure for a PMM;

FIG. 4B illustrates another example of a top-port packaging structure for a PMM;

FIG. 5A illustrates an example of a top-port packaging structure for a PMM mounted with in the casing of a device;

FIG. 5B illustrates an example of a bottom-port packaging structure for a PMM mounted with in the casing of a device;

FIG. 6 illustrates an example of a PMM assembly including a carrier substrate;

FIG. 7A illustrates an example of a PMM assembly including a carrier substrate in which the PMM package is partially embedded in a through-hole in the carrier substrate;

FIG. 7B illustrates another example of a PMM assembly including a carrier substrate in which the PMM package is partially embedded in a through-hole in the carrier substrate;

FIG. 7C illustrates another example of a PMM assembly including a carrier substrate in which the PMM package is partially embedded in a through-hole in the carrier substrate;

FIG. 8A illustrates another example of a PMM assembly including a MEMS die including the PMM and metal lid placed on different sides of the MEMS substrate PCB and with the PMM embedded in a through-hole in the carrier substrate;

FIG. 8B illustrates another example of a PMM assembly including a MEMS die including the PMM and metal lid placed on different sides of the MEMS substrate PCB and with the metal lid embedded in a through-hole in the carrier substrate;

FIGS. 9A and 9B illustrate a comparison of dimensions of the PMM assemblies of FIGS. 6 and 8B;

FIGS. 10A and 10B illustrates how the PMM assembly of FIG. 8B may be modified to include a recessed carrier substrate rather than a carrier substrate including a through-hole;

FIGS. 11A and 11B illustrates how the PMM assembly of FIG. 8A may be modified to include a recessed carrier substrate rather than a carrier substrate including a through-hole;

FIG. 12 illustrates how embodiments of a PMM assembly structure as disclosed herein may include a MEMS die with increased dimensions for greater mechanical robustness;

FIG. 13A illustrates an example of a PMM assembly including a MEMS die including the PMM and metal lid placed on different sides of the MEMS substrate PCB, with the PMM embedded in a through-hole in the carrier substrate, and with an application specific integrated circuit (ASIC) included in the MEMS die;

FIG. 13B illustrates an example of a PMM assembly including a MEMS die including the PMM and metal lid placed on different side of the MEMS substrate PCB, with the metal lid embedded in a through-hole in the carrier substrate, and with an application specific integrated circuit (ASIC) included in the MEMS die; and

FIG. 14 is a block diagram of one example of a wireless device and that can include one or more PMMs according to aspects of the present disclosure.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Aspects and embodiments disclosed herein involve engineering of the packaging and assembly of a PMM to reduce the overall assembled package size without compromising performance of the PMM.

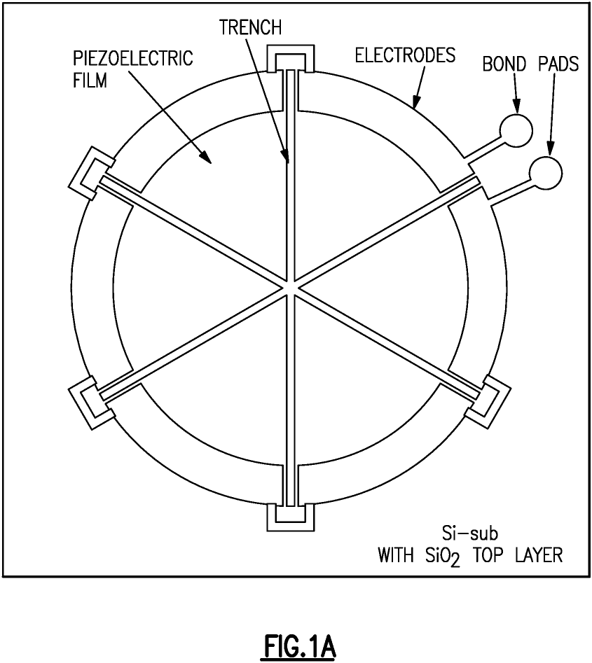

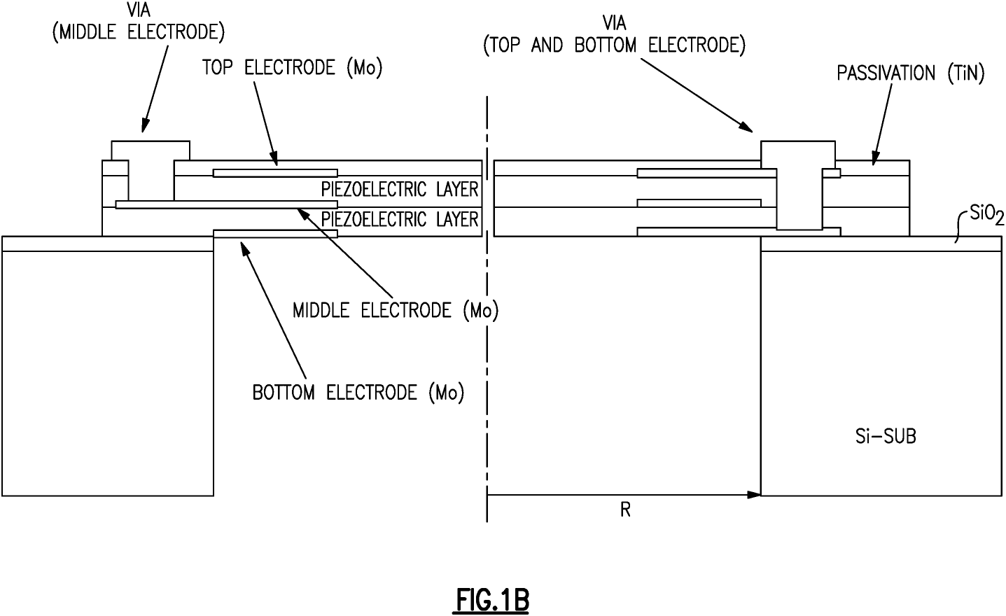

One example of a cantilever PMM is illustrated in a plan view in FIG. 1A and in a cross-sectional view in FIG. 1B. The cantilever PMM includes six cantilevers and top, middle, and bottom sensing/active electrodes proximate the bases of the cantilevers. Cantilever MEMS microphone structures generate the maximum stress and piezoelectric charges near the edge of the anchor portion of the cantilever structure. Therefore, partial sensing electrodes near the anchor may be used for maximum output energy. The cantilevers are pie-piece shaped and together form a circular microphone structure with trenches (gaps) between adjacent cantilevers. It should be appreciated that in alternate embodiments, the cantilever structures could be shaped other than as illustrated, for example, as polygons with three or more straight or curved sides.

The cantilevers of a cantilever PMM as disclosed herein may have bases mounted on a support substrate including a SiO₂ layer on a Si substrate as illustrated in FIG. 1B. The top, bottom, and middle sensing/active electrodes in the different cantilevers are connected in series between the bond pads, except for the cantilevers having electrical connection between the electrodes and bond pads. The top and bottom electrodes of each cantilever are electrically connected to the middle electrode in an adjacent cantilever. Vias to the middle electrode of one cantilever and to the top and bottom electrodes of an adjacent cantilever are used to provide electrical connection between the bond pads and cantilever electrodes. The electrodes are indicated in FIG. 1B as being Mo but could alternatively be Ru or any other suitable metal, alloy, or non-metallic conductive material.

In some embodiments, the layer of SiO₂ on the surface of the support substrate upon which the cantilevers are formed may have a thickness of from about 1 µm to about 5 µm. As illustrated in FIGS. 1A and 1B, the support substrate including the Si substrate and layer of SiO₂ typically extends outward beyond the periphery of the PMM piezoelectric material cantilevers. The layer of SiO₂ constrains the periphery of the PMM cantilevers.

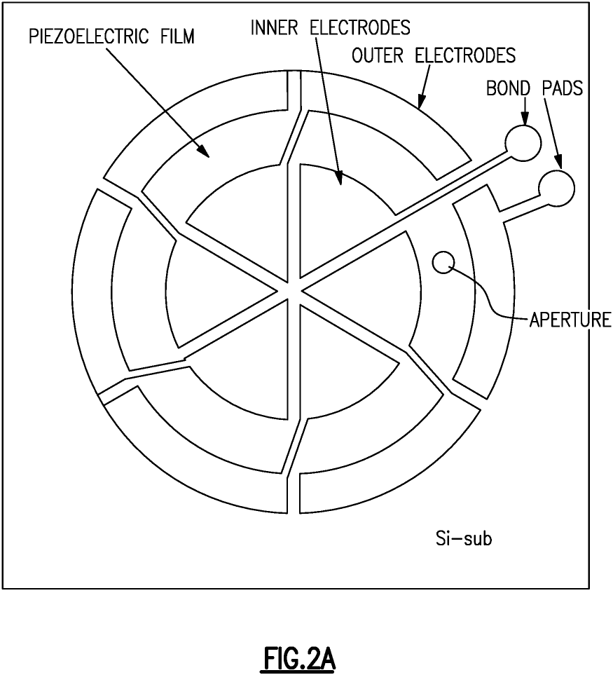

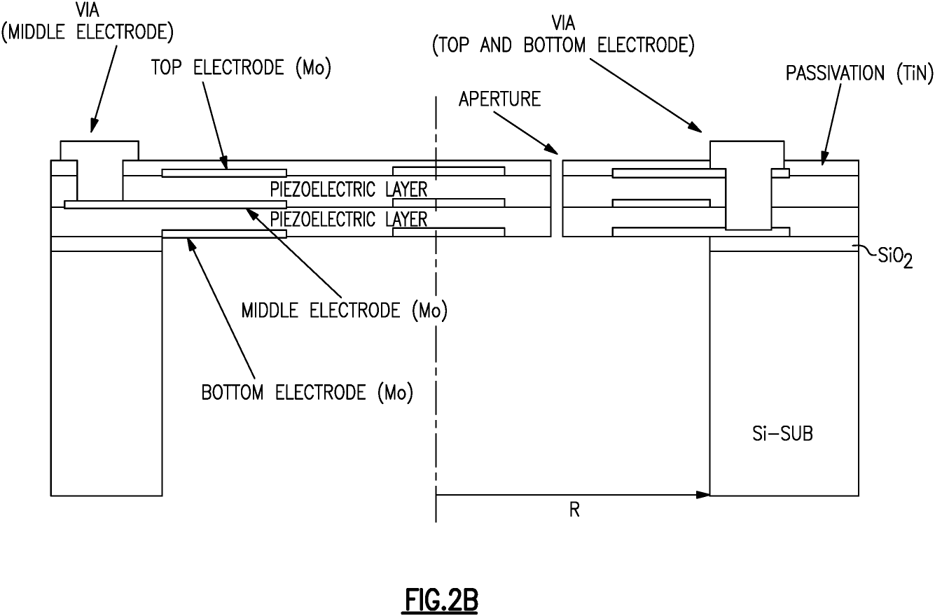

An example of a diaphragm-type piezoelectric microelectromechanical system microphone (PMM) is illustrated in a plan view in FIG. 2A and in cross-sectional view in FIG. 2B.

The diaphragm of the PMM may be formed of or include a film of piezoelectric material, for example, aluminum nitride (AlN), zinc oxide (ZnO), or PZT, (also referred to herein as a piezoelectric element) that generates a voltage difference across different portions of the diaphragm when the diaphragm deforms or vibrates due to the impingement of sound waves on the diaphragm. Although illustrated as circular in FIG. 2A, the diaphragm may have a circular, rectangular, or polygonal shape. In the example of FIGS. 2A and 2B, the diaphragm structure is fully clamped all around its perimeter by adhesion of the entire perimeter of the diaphragm to a layer of SiO₂ disposed on a Si substrate. To improve low-frequency roll-off control (f-_{3dB} control) one or more vent holes or apertures may be formed in the diaphragm structure that may be well defined by photolithography.

The diaphragm PMM of FIGS. 2A and 2B has a circular diaphragm formed of two layers of piezoelectric material, for example, AlN, that is clamped at its periphery on layers of SiO₂ formed on a Si substrate with a cavity defined in the substrate below the diaphragm. The circular diaphragm PMM includes a plurality of pie-piece shaped sensing/active inner electrodes disposed in the central region of the diaphragm that are segmented and separated from one another by gaps. Outer sensing/active electrodes, segmented and separated circumferentially from one another by gaps, are positioned proximate a periphery of the diaphragm and extend inward from the clamped periphery a portion of the radius of the diaphragm toward the inner electrodes. Each outer sensing electrode is directly electrically connected to a corresponding inner sensing electrode by an electrical trace or conductor segment. Open areas that are free of sensing/active electrodes are defined between the inner electrodes and outer electrodes.

The inner electrodes and outer electrodes each include top or upper electrodes disposed on top of an upper layer of piezoelectric material of the diaphragm and bottom or lower electrodes disposed on the bottom of the lower layer of piezoelectric material of the diaphragm. In some embodiments, as illustrated in FIG. 2B the inner electrodes and outer electrodes may further include middle electrodes disposed between the upper and lower layers of piezoelectric material. The multiple inner and outer electrodes are electrically connected in series between the two bond pads, except for inner and outer electrode segment pairs having electrical connection directly to the bond pads. The top and bottom electrodes of each inner and outer electrode segment pair are electrically connected to the middle electrode in an adjacent inner and outer electrode segment pair in embodiments including the middle electrodes. Vias to the middle electrode of one inner and outer electrode segment pair and to the top and bottom electrodes of an adjacent inner and outer electrode segment pair are used to provide electrical connection between the bond pads and electrodes. The electrodes are indicated as being Mo, but could alternatively be Ru, Pt, or any other suitable metal, alloy, or non-metallic conductive material.

Diaphragm structures generate maximum stress and piezoelectric charges in the center and near the edge of the diaphragm anchor. The charges in the center and edge have opposite polarities. Additionally, diaphragm structures generate piezoelectric charges at the top and the bottom surfaces and the charge polarities are opposite on the top and bottom surfaces in the same area. Partial sensing electrodes in the diaphragm center and near the anchor may be used for maximum output energy and sensitivity and to minimize parasitic capacitance.

A diaphragm PMM may include one, two, or multiple piezoelectric material film layers in the diaphragm. In embodiments including two piezoelectric material film layers, conductive layers forming sensing/active electrodes may be deposited on the top and the bottom of the diaphragm, as well as between the two piezoelectric material film layers, forming a bimorph diaphragm structure. Partial sensing electrodes may be employed. Inner electrodes may be placed in the center of diaphragm and outer electrodes may be placed near the anchor/perimeter of the diaphragm. Sensing/active electrodes may be placed on the bottom and top, and in the middle of the vertical extent of the multi-layer piezoelectric film forming the diaphragm. The size of the sensing/active electrodes may be selected to collect the maximum output energy (E=0.5*C*V²).

The packaging and assembly methods and structures disclosed herein may be utilized with either cantilever or diaphragm type PMMs.

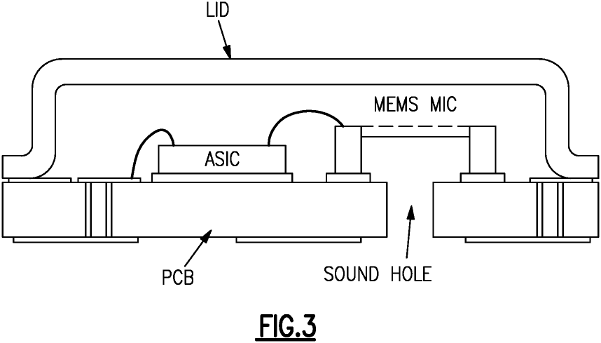

One form of package for a PMM is a bottom-port package, an example of which is illustrated in FIG. 3. The PMM is mounted on a printed circuit board (PCB), often along with an application specific integrated circuit (ASIC) with control circuitry for the PMM and covered by a lid that may be formed of metal. A sound hole is defined in the PCB for sound to reach the PMM.

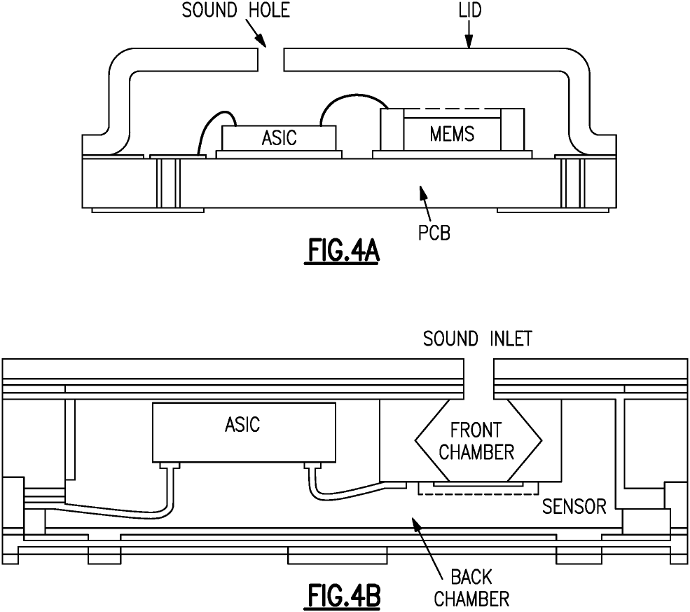

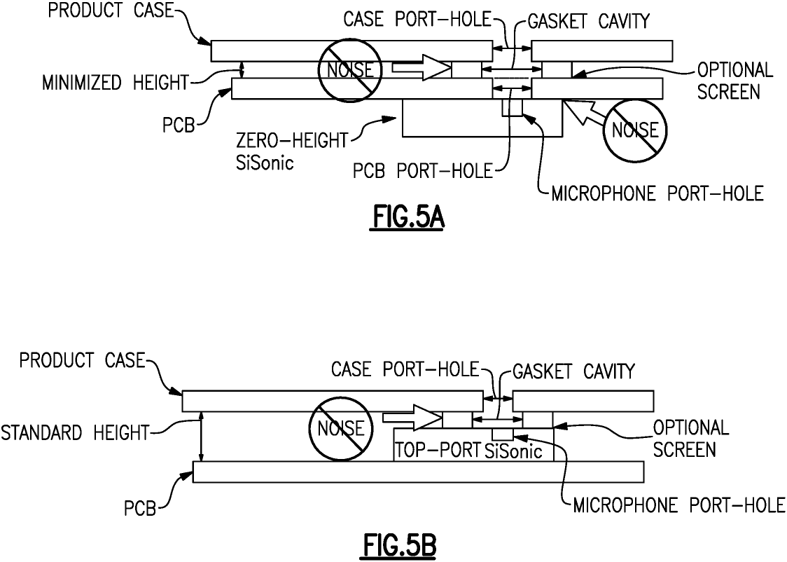

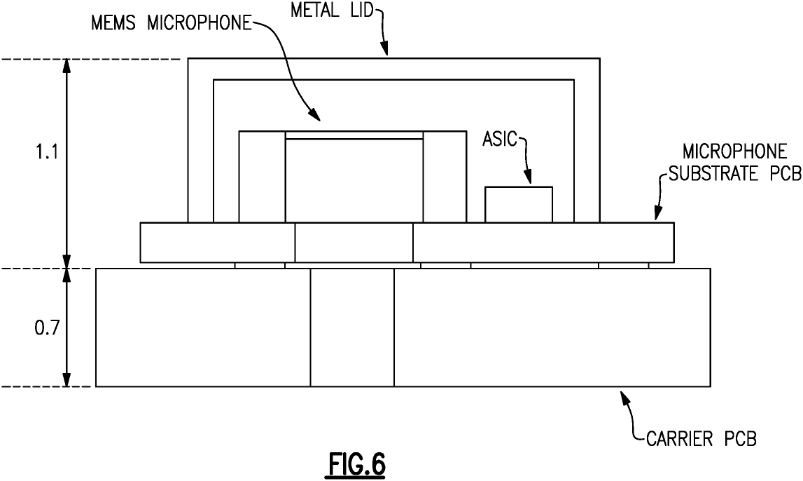

Another form of package for a PMM is a top-port package, an example of which is illustrated in FIG. 4A. The top-port package is similar to the bottom-port package, but the sound port is defined in the lid rather than in the PCB. A variation of a top-port package is shown in FIG. 4B, in which the PMM and ASIC are mounted on the lid, which is formed of a laminate such as a PCB that is attached to a bottom PCB by walls also formed of laminate material. FIGS. 5A and 5B illustrate how a top-port and bottom-port PMM package, respectively, may be assembled onto the case of a device along with gaskets to minimize sound interference and sound holes in the device casing.

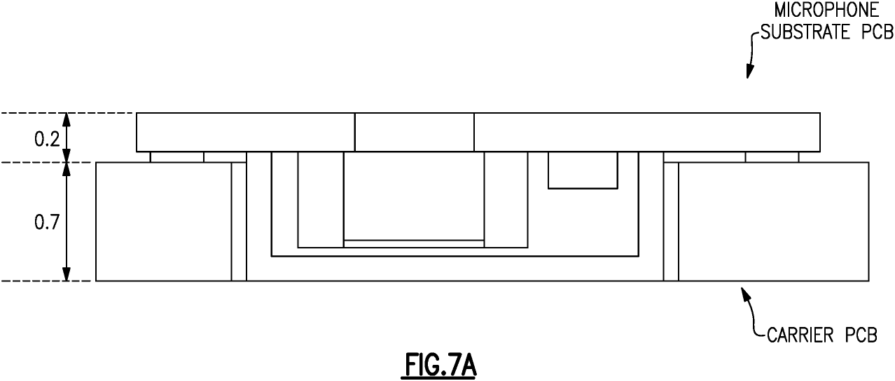

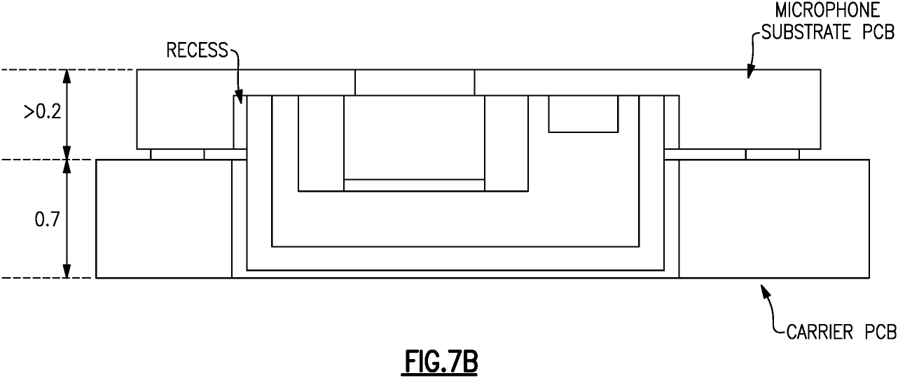

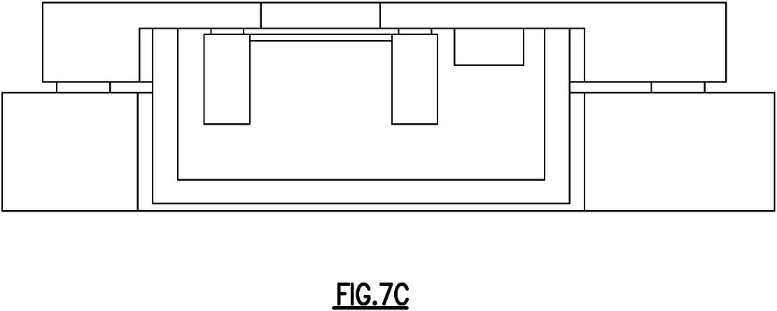

In many instances PMM packages are assembled on to carrier PCBs for ease of handling and for mechanical support. One example of a PMM assembly including a carrier substrate is illustrated in FIG. 6 in which examples of height dimensions in mm are shown. The carrier PCB (~0.7 mm) is typically much thicker than the microphone substrate PCB (~0.2 mm), therefore, a similar or larger back volume can be obtained by making a through hole (or a recess) on the carrier PCB and embedding at least a part of the PMM package, for example, at least a portion enclosed by the lid, into the through hole/recess, as shown in FIG. 7A. If the carrier PCB is not thick enough, or larger microphone back volume (the space defined within the lid) is desired, a method as shown in FIG. 7B can be utilized. In this method of FIG. 7B the thickness of microphone substrate PCB can be increased. A recess or through-hole is made in the carrier PCB in which the PMM package lid is embedded, thus providing a larger back volume than in the embodiment shown in FIG. 7A. It can be seen that the assembly configurations illustrated in FIGS. 7A and 7B have heights reduced by about half as compared to the assembly configuration of FIG. 6. In a variation on the embodiment of FIG. 7B, in another embodiment illustrated in FIG. 7C the MEMS die including the PMM may be flipped relative to its orientation in FIG. 7B. In this way, the performance can be further improved as the back volume is increased and the front cavity volume is reduced.

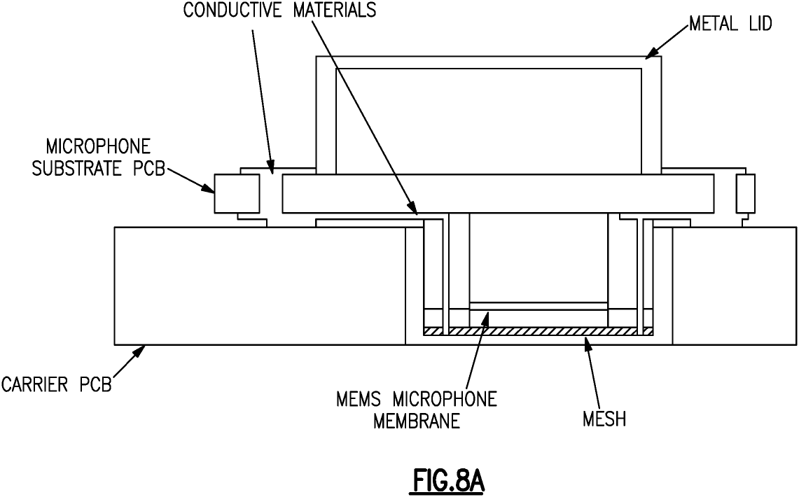

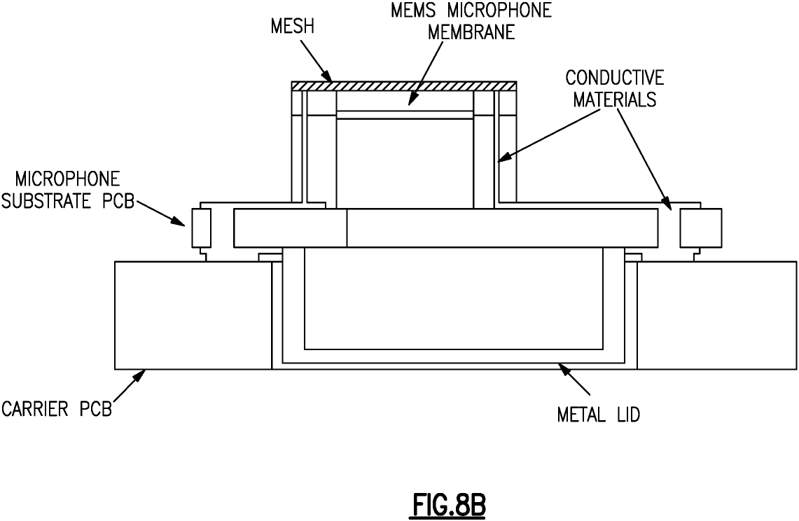

In some embodiments, the MEMS die including the PMM can be placed on a different side of the microphone substrate PCB than the lid. The PMM package may be assembled into a carrier PCB having a through-hole or a recess. The PMM package can be mounted to the carrier PCB with the MEMS die fitted into the carrier PCB through-hole as illustrated in FIG. 8A, or with the lid fitted into the carrier PCB through-hole as illustrated in FIG. 8B. Even though the package size of PMM is larger in these embodiments than in previously described embodiments, the size will be reduced after assembly with the carrier PCB as the lid or PMM die is embedded into the carrier PCB.

To provide shielding against E-field, EM, or RF interference, the whole microphone package can be encapsulated by conductive materials by metal passing through a PCB via, through a silicon via, by a metal coating the outside of the package, etc., as illustrated in the examples of FIGS. 8A and 8B.

A mesh can be added on top of the PMM to provide protection to the PMM membrane. The mesh can also be conductive to provide shielding against E-field, EM, or RF interferences. The conductive mesh can also be grounded to improve the shielding.

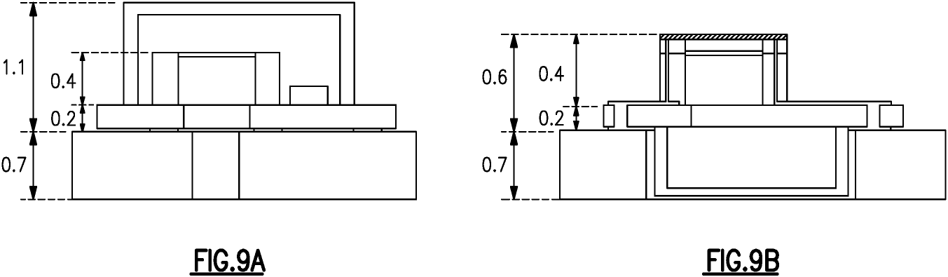

FIGS. 9A and 9B show a comparison of PMM assemblies as illustrated in FIGS. 6 and 8B in which example dimensions in mm are included. The PMM assembly illustrated in FIG. 8B as compared to that illustrated in FIG. 6 has height reduced from 1.1 mm to 0.6 mm, while back volume is increased by 71%.

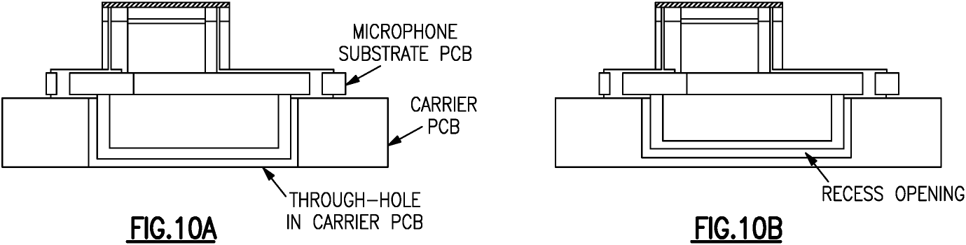

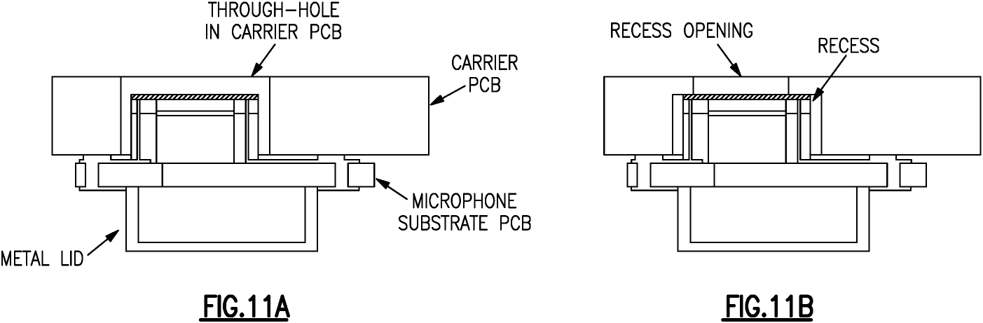

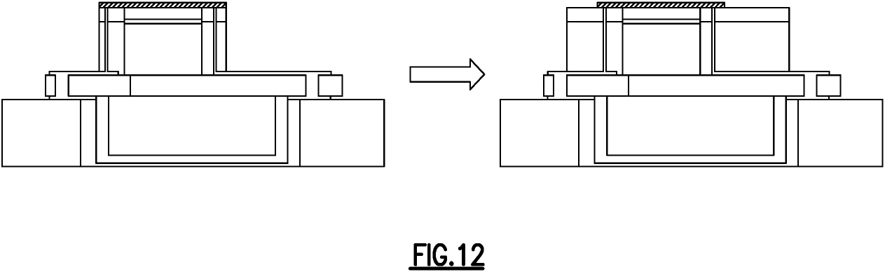

In the various embodiments disclosed above, a through-hole is provided in the carrier substrate to house at least a portion of the PMM package. As illustrated in the comparison between the assemblies of FIGS. 10A and 10B, instead of a through-hole, a recess may be provided in the carrier substrate to house at least a portion of the PMM package. If a recess on the carrier PCB is used instead of through-hole to house the MEMS die portion of the PMM package, then an opening may be formed from within the recess to the outside environment as illustrated in the comparison of embodiments in FIGS. 11A and 11B.

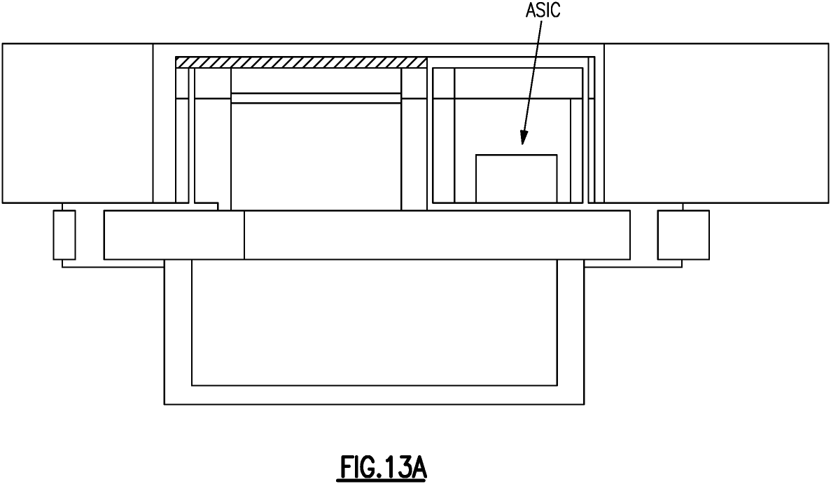

In various embodiments of the assembly structures disclosed herein, as illustrated in FIG. 12, the areas of the MEMS die around the MEMS membrane can be extended to provide higher mechanical robustness which could be helpful for gasket mounting during the product assembly.

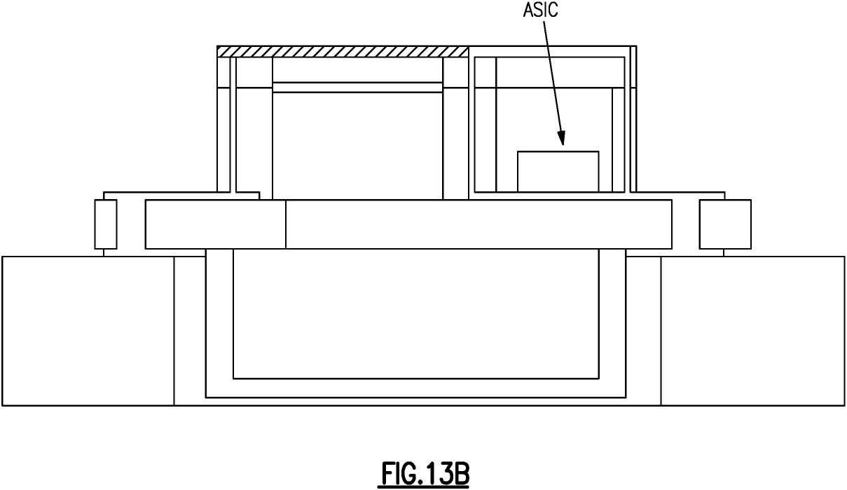

Any of the assembly structures disclosed herein may be modified to include an ASIC within the packaged structure, for example, on the MEMS die, as illustrated in the examples of FIGS. 13A and 13B.

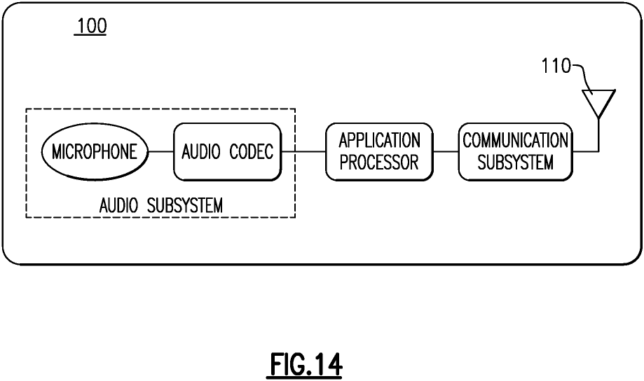

Examples of MEMS microphones and assembly structures including same as disclosed herein can be implemented in a variety of packaged modules and devices. FIG. 14 is a schematic block diagrams of an illustrative device 100 according to certain embodiments.

The wireless device 100 can be a cellular phone, smart phone, tablet, modem, communication network or any other portable or non-portable device configured for voice or data communication. The wireless device 100 can receive and transmit signals from the antenna 110.

The wireless device 100 may include one or more microphones as disclosed herein. The one or more microphones may be included in an audio subsystem including, for example, an audio codec. The audio subsystem may be in electrical communication with an application processor and communication subsystem that is in electrical communication with the antenna 110. As would be recognized to one of skill in the art, the wireless device would typically include a number of other circuit elements and features that are not illustrated, for example, a speaker, an RF transceiver, baseband sub-system, user interface, memory, battery, power management system, and other circuit elements.

The principles and advantages of the embodiments can be used for any systems or apparatus, such as any uplink wireless communication device, that could benefit from any of the embodiments described herein. The teachings herein are applicable to a variety of systems. Although this disclosure includes some example embodiments, the teachings described herein can be applied to a variety of structures. Any of the principles and advantages discussed herein can be implemented in association with RF circuits configured to process signals in a range from about 30 kHz to 10 GHz, such as in the X or Ku 5G frequency bands.

Aspects of this disclosure can be implemented in various electronic devices. Examples of the electronic devices can include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a stereo system, a digital music player, a radio, a camera such as a digital camera, a portable memory chip, a washer, a dryer, a washer/dryer, a copier, a facsimile machine, a scanner, a multifunctional peripheral device, a wrist watch, a clock, etc. Further, the electronic devices can include unfinished products.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A piezoelectric microelectromechanical system microphone assembly comprising:
a carrier substrate including one of a through-hole or a recess; and
a package including a microelectromechanical system die having a piezoelectric microelectromechanical system microphone mounted on a microphone substrate and a lid, at least a portion of the package disposed within the one of the through-hole or recess.

2. The assembly of claim 1 wherein the lid is a metal lid.

3. The assembly of claim 1 wherein the lid is at least partially disposed within the one of the through-hole or recess.

4. The assembly of claim 3 wherein the lid is fully disposed within the one of the through-hole or recess.

5. The assembly of claim 3 wherein an upper surface of the lid is substantially co-planar with a lower surface of the carrier substrate.

6. The assembly of claim 1 wherein the lid is formed over the microelectromechanical system die and, together with the microphone substrate, defines a back volume around the piezoelectric microelectromechanical system microphone.

7. The assembly of claim 1 wherein the package is a bottom-port package.

8. The assembly of claim 7 wherein a piezoelectric membrane of the piezoelectric microelectromechanical system microphone is disposed proximate the bottom port and between the bottom port and a support substrate for the piezoelectric membrane.

9. The assembly of claim 1 wherein the lid and microelectromechanical system die are disposed on opposite sides of the microphone substrate.

10. The assembly of claim 9 wherein the microelectromechanical system die is at least partially disposed within the one of the through-hole or the recess.

11. The assembly of claim 9 wherein the one of the through-hole or the recess is the recess, and the carrier substrate further includes an opening providing acoustic communication between the microelectromechanical system microphone and an environment outside of the package.

12. The assembly of claim 9 wherein the lid is at least partially disposed within the one of the through-hole or the recess.

13. The assembly of claim 9 wherein the one of the through-hole or the recess is the through-hole.

14. The assembly of claim 1 wherein the package is encapsulated by a conductive material.

15. The assembly of claim 1 further comprising a mesh disposed over a piezoelectric membrane of the microelectromechanical system microphone.

16. The assembly of claim 15 wherein the mesh is conductive.

17. The assembly of claim 16 wherein the mesh is grounded.

18. The assembly of any claim 1 further including an application specific integrated circuit disposed within the package.

19. An electronics device module including the assembly of claim 1.

20. An electronic device including the electronic device module of claim 19.
